(19) United States
(12) Patent Application Publication
(10) Pub. No.: US 2013/0036935 A1
(43) Pub. Date: Feb. 14, 2013

(54) TRACK SUPPORT FOR MAGNETIC LEVITATION VEHICLES

(71) Applicants: Markus Bauer, Freising (DE); Qinghua Zheng, Taufkirchen (DE)

(72) Inventors: Markus Bauer, Freising (DE); Qinghua Zheng, Taufkirchen (DE)

(21) Appl. No.: 13/642,681

(22) PCT Filed: Apr. 29, 2011
(86) PCT No.: PCT/EP2011/056868

§ 371 Date: Oct. 22, 2012

(30) Foreign Application Priority Data
May 19, 2010 (DE) 10 2010 017 030.5

(51) Int. Cl. E01B 25/30; B05D 1/08; B61B 13/08; B05D 1/02

(52) U.S. Cl. 104/286; 427/446

(57) ABSTRACT

The guideway support comprises at least one gliding surface (14, 19, 34) for magnetic levitation vehicles (4), which have at least one skid (8) designated for placement on the gliding surface (14, 19, 34), wherein the gliding surface (14, 19, 34) is provided with a low-friction, multi-layered coating having at least one ceramic layer (15, 22, 35, 36) arranged on the gliding surface (14, 19, 34). The guideway support is characterized in that at least one non-ceramic layer (17, 23, 37), produced in a thermal spraying process, is arranged on the ceramic layer (15, 22, 35, 36).

The invention relates to a track support for magnetic levitation vehicles comprising at least one sliding surface according to the preamble of claim 1, and a method for coating the sliding surface of such a track support according to the preamble of claim 11. Sliding surfaces on track supports for magnetic levitation vehicles are used in emergency situations, for example in case of power failure or damage to support magnets, in order to safely set down the vehicles even at high speeds. The vehicles comprise appropriate undercarriage skids for this purpose. if the sliding surfaces are provided with a friction-reducing coating, the travel of the magnetic levitation vehicle on the sliding surfaces can be continued, advantageously, to the next transfer opportunity for passengers or to the nearest repair facility.

Document DE 10 2004 028 948 discloses a track carrier for a magnetic levitation vehicle that comprises a sliding surface. A single- or multiple-layer ceramic layer is applied to said sliding surface by way of a flame-spraying process. Said layer is relatively thin, and so the roughness of the sliding surfaces is also apparent in the ceramic layer. For smoothing, an outer layer made of a resin system is disposed on the ceramic layer, which is applied to the ceramic surface using a wet-chemical spraying or rolling method. This application method has been thoroughly proven for use with a resin system.

However, after the wet-chemical application of the resin system using a spraying or rolling process, time-consuming drying must be carried out under controlled climate conditions (temperature, air humidity). This complicates the production of the track supports and results in delays of operation of the magnetic levitation railway if on-site repairs are performed on track supports having damaged coatings of the sliding surface. A problem addressed by the present invention is therefore that of creating a track support comprising a coated sliding surface that can be manufactured efficiently. A further problem is that of providing a method for coating a sliding surface of a track support that can be used to manufacture a track support and to repair a damaged coating of a track support in less time.

The invention solves said problems by way of a track support having the features of claim 1 and by way of a method having the features of claim 11.

The track support for magnetic levitation vehicles according to the invention comprises at least one sliding surface, on which magnetic levitation vehicles having at least one undercarriage skid can be placed. The sliding surface is provided with a low-friction, multiple-layer coating having at least one ceramic layer disposed on the sliding surface. The track support is characterized in that at least one non-ceramic layer, which is produced in a thermal spraying process, is disposed on the ceramic layer.

The method according to the invention for coating at least one sliding surface of a track support for magnetic levitation vehicles comprises the following steps. At least one ceramic layer is applied to the at least one sliding surface of the track support by way of a thermal spraying process. Next, a non-ceramic layer is applied to the at least one ceramic layer by way of a thermal spraying process, more particularly by flame-spraying.

The thermal spraying process for applying the non-ceramic layer makes it possible to produce or repair track supports in less time since the drying time associated with a wet-chemical application method is eliminated. Application is also simplified since the complex conditioning of the sliding surface during the application and drying of the coating can be eliminated.

In a preferred embodiment of the track support, the non-ceramic layer comprises a polymer, more particularly polyethylene and/or polypolyetherketone and/or polyetheretherketone. These materials are thermally sprayable and are well-suited in terms of tribology.

In a preferred embodiment of the method, in order to apply the non-ceramic layer, the sliding surface pre-coated with the at least one ceramic layer is preheated. Adhesion of the non-ceramic layer is improved in this manner. Particularly preferably, the sliding surface pre-coated with the at least one ceramic layer is preheated by way of the thermal spraying process in order to apply the ceramic layer. In this manner, the coating process becomes particularly efficient in terms of time and the energy to be used.

Further advantageous embodiments and developments are set forth in the dependent claims.

The invention is explained below in greater detail with reference to the attached drawings of exemplary embodiments. The drawings show:

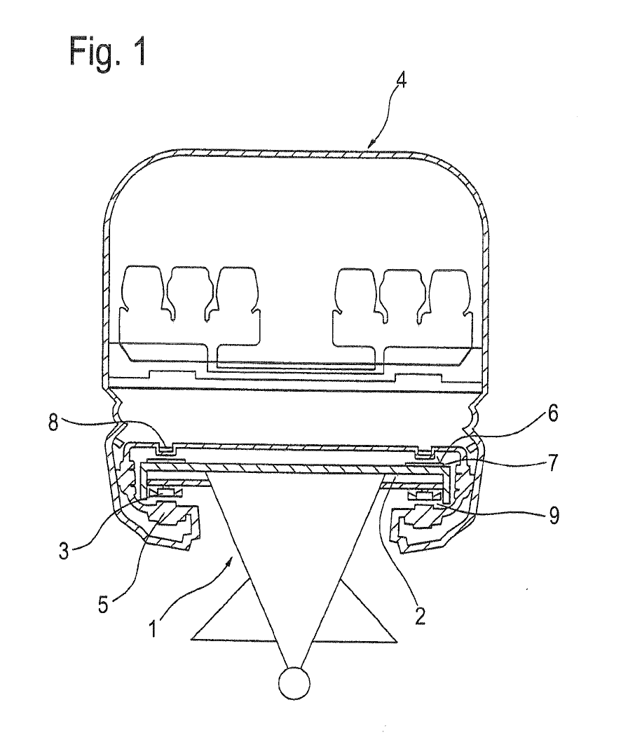

FIG. 1 a schematic cross section of a magnetic levitation railway comprising a track support and a vehicle;

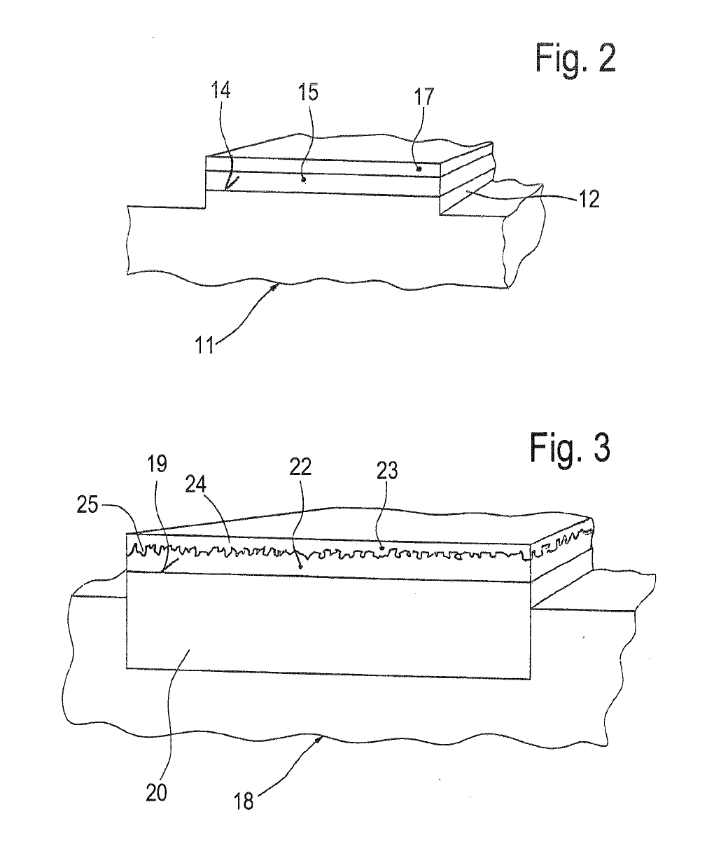

FIG. 2 a schematic, perspective partial view of a track support made of concrete, comprising a sliding surface, which is also made of concrete;

FIG. 3 a partial view, corresponding to FIG. 2, of a track support made of concrete and having a coated sliding surface made of steel; and

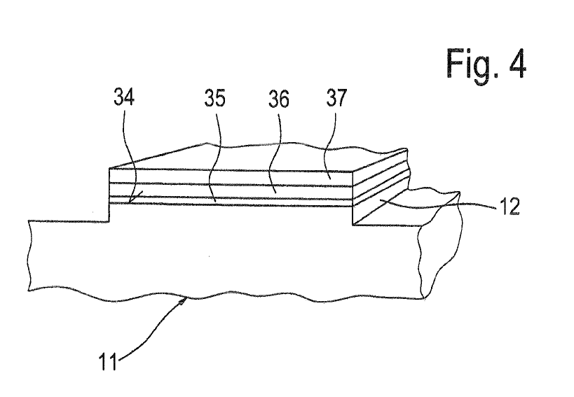

FIG. 4 a partial view, corresponding to FIG. 2, of a track support made of concrete, in a further exemplary embodiment.

FIG. 1 schematically shows a cross section of a magnetic levitation railway comprising a drive in the form of an elongated-stator linear motor. The magnetic levitation railway contains a plurality of track supports 1, which are disposed one after the other in the direction of a predefined route and carry stator cores 3, which are equipped with windings and are mounted on the undersides of track slabs 2. Vehicles 4 comprising support magnets 5 can travel along the track support 1, said support magnets being disposed opposite the undersides of the stator cores 2 (3?) and simultaneously providing the excitation field for the elongated-stator linear motor. Sliding surfaces 6 extending in the direction of travel are provided on the top sides of the track slabs 2 and are designed, for example, as the surfaces of special slider strips 7 fastened to the track slabs 2. The sliding surfaces 6 cooperate with undercarriage skids 8, which are mounted to the undersides of the vehicles 4 and are supported on the sliding surfaces 6 when the vehicles 4 are at a standstill, and therefore relatively large gaps 9 are present between the stator cores 3 and the support magnets 5. A carbon ceramic reinforced with carbon fibers and enriched with SiC, for example, can be used as the material for the surface of the undercarriage skids 8. In preparation for travel, first the support magnets 5 are activated in order to lift the undercarriage skids 8 off of the sliding surfaces 6 and set the size of the gap 9 created in the state of levitation to 10 mm, for example. The vehicle 4 is then set into motion.

Magnetic levitation railways of this type are generally known to a person skilled in the art (e.g. “Neue Verkehrstechnologien” [New Transportation Technologies], Henschel Magnetfahrtechnik 6/86).

FIG. 2 shows a track support 11 made of concrete, which is equipped on the top side thereof with a raised area or strip 12 integrally produced therewith, which has a sliding surface 14 on the top side thereof for the undercarriage skids 8 of the magnetic levitation vehicle 4 according to FIG. 1. Such concrete track supports 11 are known, for example, from the publications ZEV-G1as.Ann 105, 1989, pages 205-215 or “Magnetbahn Transrapid, die neue Dimension des Reisens” [Transrapid Magnetic Levitation Railway, the New Dimension of Travel], Hestra Verlag Darmstadt 1989, pages 21-23, which are hereby made subject matter of the present disclosure via reference thereto.

The sliding surfaces 14 are provided with a multiple-layer coating. The coating comprises at least one ceramic layer and one non-ceramic layer. In the example in FIG. 2, the coating is formed of exactly two layers disposed one on top of the other, a ceramic layer 15 and a non-ceramic layer 17. The number of two layers is not limiting, however. For example, a plurality of ceramic layers can also be provided one above the other, onto which a non-ceramic layer is ultimately applied. Within the scope of the present application, the surface 14 of the strip 12 is referred to as the sliding surface and the layer comprising the applied layers, which are the ceramic layer 15 and the non-ceramic layer 17 in this case, are referred to as the coating of the sliding surface 14.

The ceramic layer 15, which is applied directly to the sliding surface 14 of the track support 1 made of concrete and prepared by way of sand blasting, for example, can be an aluminum oxide layer, for example. Alternatively, the ceramic layer 15 can contain a mixture comprising 50 to 99.9 mass percentage aluminum oxide and 50 to 0.1 mass percentage titanium oxide. A material forms that has great hardness and relatively great viscosity, which results in good adhesion on the concrete and at least partially compensates for the different thermal expansions of the individual components.

The ceramic layer 15 is preferably applied in a thermal spraying process. Plasma, arc discharge and laser spraying and, more particularly, flame and high-velocity flame spraying are suitable. The starting materials can be supplied in powder form, for example.

The non-ceramic layer 17 is also applied in a thermal spraying process. To prevent decomposition of the non-ceramic starting materials, a flame-spraying process is suitable, for example, in which the starting materials are brought into the flame by way of an inert gas flow. The non-ceramic layer 17 and, therefore, the entire coating, is ready for use immediately after application.

Polyethylene (PE) and, more particularly, ultra-high molecular-weight polyethylene (UHMW-PE) are suitable materials for the non-ceramic layer 17. PE is low-price and has good properties in terms of friction (tribology). Alternative materials are polyetherketone, preferably polyetheretherketone (PEEK) or mixtures of PE and PEEK. Modified epoxide resin can also be used, in which an epoxide resin in the form of flowable prepolymer is combined with graphite particles and/or glass beads that are preferably hollow. A thickness in the range of 0.1 to 0.2 mm is well suited as the layer thickness.

Additives can be contained, more particularly to reduce friction and, therefore, wear in the non-ceramic layer 17 of the coating. Such additives are preferably graphite or polytetrafluoroethylene (PTFE).

FIG. 3 shows a section of a track support in a further exemplary embodiment. This is a driveway having a sandwich structure and containing a plurality of track supports 18, which are disposed one after the other and are made of concrete, in the top surfaces of which slider strips 20 made of steel and equipped with sliding surfaces 19 are inserted. In the exemplary embodiment, the sliding surfaces 19 protrude slightly past the surface of the rest of the track support 18 and can be provided with a corrosion-protection layer in a manner known per se.

In turn, a ceramic layer 22 is applied onto the sliding surface 19, on which a non-ceramic layer 23 is disposed. With respect to the materials that can be used for the layers 22 and 23, reference is made to the corresponding layers 15 and 17 of the exemplary embodiment in FIG. 2.

For purposes of illustration, the roughness of the ceramic layer 22 is exaggerated in the exemplary embodiment according to FIG. 3 in order to show roughness points 24 and roughness troughs 25. One cause of the roughness of the ceramic layer 22 is the resulting roughness of a raw foundation, as is the case, for example, with the strip 12 made of concrete in the exemplary embodiment depicted in FIG. 2. However, in the slider strip 20 made of steel and used in this exemplary embodiment, the ceramic layer 22 also forms a rough surface, more particularly when it is applied by way of a thermal spraying process.

Direct contact of the undercarriage skids 8 with the rough surface of the ceramic layer 22 would result in ultimate and favorable sliding properties setting in only after a certain break-in period and after the roughness points 24 have worn off, which is undesirable. The non-ceramic layer 23 fills the roughness troughs 25 of the ceramic layer 22 and thereby provides a tribologically advantageous, smooth contact surface for the undercarriage skids 8.

In the exemplary embodiment according to FIG. 4, the sliding surface 34 of the track support comprises such a three-layer coating. In this case, two ceramic layers 35 and 36 are provided one over the other, on which a non-ceramic layer 37 is disposed.

The first ceramic layer 35 has a material composition, for example, that is the same as that of the ceramic layer 15 described in FIG. 2. The second ceramic layer 36, however, contains a mixture comprising at least 90 mass percentage, preferably 95 mass percentage Al₂O₃ and a maximum of 10 mass percentage, preferably a maximum of 5 mass percentage TiO₂. The second ceramic layer 36 can also contain additives, more particularly graphite or PTFE. Due to the modified material composition, the second ceramic layer 36 has wear and sliding properties that are more favorable compared to the first inner layer 35. As in the above-described exemplary embodiments, the non-ceramic layer 17 is also used to provide a smooth surface of the coating.

In all exemplary embodiments, the non-ceramic layer 17, 23, 37 made of PE or PEEK can be applied in an (inert gas) flame-spraying process. Good adhesion is achieved when the substrate, that is, the sliding surface 14, 19, 34 comprising the applied ceramic layer(s) 15, 22, 35, 36, is preheated. The preheating temperatures are dependent on the parameters of the flame-spraying process and are preferably in the range of 100° C. to 150° C. for the application of the ceramic layers and for flame coating with polymers.

If the ceramic layer or layers 15, 22, 35, 36 are also applied in a thermal spraying process, more particularly the flame spraying process, the application of these layers alone results in heating of the sliding surfaces 14, 19, 34 and the applied ceramic layers 15, 22, 35, 36 themselves. This heating can be used to advantage as preheating for the application of the non-ceramic layer 17, 23, 37. The preferred preheating temperature can be adjusted by way of a time delay between the application of the ceramic layer and the non-ceramic layer.

The above-described method for coating the sliding surfaces of a driveway can be used on-site to manufacture track supports and to repair a damaged coating. The method will be described once more in greater detail by reference to two examples.

### Example 1

A track support made of concrete, which is already provided at the plant with a coating designed according to DE 103 14 068, for example, is damaged in such a way that the coating was worn off of the sliding surface of the track support, at least in sections.

For repair, the section of the track support at which the damage occurred is sand-blasted without having been disassembled. Next, compressed air is used to remove remaining blasting particles from the surface to be coated. On the surface, which has been thusly pretreated and roughened and cleaned, a viscous and hard ceramic layer comprising a mixture of Al₂O₃ and TiO₂ is applied by flame spraying or flame-powder spraying. The ceramic layer comprises 60 mass percentage Al₂O₃ and 40 mass percentage TiO₂ and has a thickness of 50±5 μm. A non-ceramic layer is applied, as a cover layer, to the sliding surface, which comprises the ceramic layer and is still preheated by way of the application of the ceramic layer, also by way of a flame-spraying process. Said cover layer results in smoothing of the surface and has water-and contamination-repelling properties. The cover layer comprises ultra-high molecular-weight polyethylene (UHMW-PE) having a mean layer thickness of 150±15 μm. The entire layer thickness of the coating is therefore 200±20 μm.

### Example 2

In a method for manufacture at the plant, a track support made of concrete is first pretreated by way of grinding. Next, three individual layers, similar to an arrangement according to FIG. 4, are applied to the sliding surface of the track support. A first ceramic layer is applied to the sliding surface. It comprises 60 mass percentage Al₂O₃ and 40 mass percentage TiO₂, with a mean layer thickness of approximately 50 μm.

A second ceramic layer is applied simultaneously or immediately after application of the first ceramic layer along the length and width of the sliding surface of the track support. It comprises 97 mass percentage Al₂O₃ and 3 mass percentage TiO₂. The first and second ceramic layers are applied by way of flame spraying, in which a fuel gas-oxygen flame is used to heat a pulverized, cord-shaped, rod-shaped or wire-shaped coating material and is applied to a base material at high velocity with application of additional compressed air.

In the present case, an arrangement of three burners, which are disposed one behind the other relative to the sliding surface and are moved over the sliding surface at a predefined speed, are used to apply the first and second ceramic layers and a non-ceramic layer as the third layer. A coating mixture for application of the first ceramic layer is fed to the front burner and a coating mixture for application of the second ceramic layer is fed to the middle burner, thereby advantageously making it possible to simultaneously apply both layers 35 and 36.

The non-ceramic layer is applied by way of the third, rear burner of the burner arrangement as soon as the previous ceramic layers have been completely applied to the sliding surface. The operating parameters of the first two burners, the distance of the burners with respect to one another, and the feed rate of the burner arrangement determines the preheating temperature at which the application of the non-ceramic layer takes place. At predefined operating parameters of the first two burners and a predefined feed rate, it is possible, more particularly, to select the distance between the burners such that a desired preheating temperature sets in. To apply the non-ceramic layer, a polymer mixture is fed to the third burner, possibly with application of inert gas. Said mixture contains a polyetherketone, preferably modified PEEK, and additives suchs as polytetrafluoroethylene, graphite and relatively short carbon fibers. The third outer layer has a layer thickness of approximately 150 μm.

What is claimed is:

1. A track support comprising at least one sliding surface (14, 19, 34) for magnetic levitation vehicles (4) that have at least one undercarriage skid (8) designed for setting down onto the sliding surface (14, 19, 34), wherein the sliding surface (14, 19, 34) is provided with a low-friction, multiple-layer coating having at least one ceramic layer (15, 22, 35, 36) disposed on the sliding surface (14, 19, 34), characterized in that at least one non-ceramic layer (17, 23, 37), produced in a thermal spraying process, is disposed on the ceramic layer (15, 22, 35, 36).

2. The track support according to claim 1, in which the non-ceramic layer (17, 23, 37) comprises a polymer.

3. The track support according to claim 2, in which the non-ceramic layer (17, 23, 37) comprises polyethylene and/or polypolyetherketone and/or polyetheretherketone.

4. The track support according to claim 3, in which the polyethylene is an ultra-high molecular-weight polyethylene having a mean molar mass of more than 1000 kg/mol, preferably more than 3000 kg/mol.

5. The track support according to claim 2, in which the non-ceramic layer (17, 23, 37) comprises an epoxide resin.

6. The track support according to claim 1, in which the non-ceramic layer (17, 23, 37) contains at least one sliding means additive.

7. The track support according to claim 6, in which the sliding means additive is graphite or polytetrafluoroethylene.

8. The track support according to claim 1, in which the non-ceramic layer (17, 23, 37) also contains carbon fibers.

9. The track support according to claim 1, in which the at least one ceramic layer (15, 22, 35, 36) comprises aluminum oxide or aluminum oxide and titanium oxide and is produced in a thermal spraying process.

10. The track support according to claim 1, in which the thermal spraying process for application of the non-ceramic layer (17, 23, 37) and/or the thermal spraying process for application of the ceramic layer (15, 22, 35, 36) is a flame-spraying process.

11. A method for coating at least one sliding surface (14, 19, 34) of a track support (1) for magnetic levitation vehicles (4), comprising the following steps:
a.) apply at least one ceramic layer (15, 22, 35, 36) onto at least the sliding surface (14, 19, 34) of the track support by way of a thermal spraying process, and
b.) apply a non-ceramic layer (17, 23, 37) to the at least one ceramic layer (15, 22, 35, 36) by way of a thermal spraying process, more particularly by way of flame spraying.

12. The method according to claim 11, in which the sliding surface (14, 19, 34) precoated with the at least one ceramic layer (15, 22, 35, 36) is preheated for application of the non-ceramic layer (17, 23, 37).

13. The method according to claim 12, in which the sliding surface (14, 19, 34) precoated with the at least one ceramic layer (15, 22, 35, 36) is preheated by way of the thermal spraying process for application of the ceramic layer (15, 22, 35, 36).
